(19) United States
(12) Patent Application Publication
(10) Pub. No.: US 2017/0185425 A1
(43) Pub. Date: Jun. 29, 2017

(54) Mnemonic Support of Users in Guided Activity Floorplans

(71) Applicant: SAP SE, Walldorf (DE)

(72) Inventors: Andrea Kristen, Berlin (DE); Yassen Kolarov, Berlin (DE); Ulrike Jansen, Berlin (DE); Torsten Strahl, Kleinmachnow (DE)

(21) Appl. No.: 14/982,653

(22) Filed: Dec. 29, 2015

(51) Int. Cl. G06F 9/44; G06F 3/0484; G06F 3/0481

(52) U.S. Cl. CPC G06F 9/4446; G06F 3/0481; G06F 3/0484

(57) ABSTRACT

Methods and systems that facilitate the generation, presentation, and adaptation of an anchored information bar, associated with a guided activity floorplan or wizard, in support of assisting users as they complete the different steps of a complex task as the user employs software applications (and associated user interfaces) on their devices to go about their different activities.

### BACKGROUND

Today users are frequently presented with complex tasks as they employ software applications (and associated user interfaces) on their devices to go about their different activities. Guided activity floorplans, or wizards, can assist users in completing such tasks. Although guided activity floorplans are meant to streamline complex tasks, there are circumstances under which they can actually increase the complexity for users.

### BRIEF DESCRIPTION OF THE DRAWINGS

The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 presents various steps of an illustrative task.

FIG. 2 depicts aspects of one particular positioning option (horizontal) for an illustrative anchored information bar.

FIG. 3 depicts aspects of one particular positioning option (horizontal) for an illustrative anchored information bar.

FIG. 4 depicts aspects of one particular positioning option (vertical) for an illustrative anchored information bar.

FIG. 5 depicts aspects of device type and orientation particulars.

FIG. 6 depicts aspects of device type and orientation particulars.

FIG. 7 depicts aspects of an illustrative additional service.

FIG. 8 is a block diagram illustrating an exemplary computer system, according to an embodiment.

Like reference symbols in the various drawings indicate like elements

### DETAILED DESCRIPTION

Embodiments of techniques for guiding user activities are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment,” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In the discussion below, ‘device’ refers to a logical and/or a physical unit adapted for a specific purpose. For example, a device may be at least one of a mechanical and/or an electronic unit. Device encompasses, but is not limited to, a communication device, a computing device, a handheld device, and a mobile device such as an enterprise digital assistant (EDA), a personal digital assistant (PDA), a tablet computer, a smartphone, a smartwatch, a desktop computer, a laptop computer, and the like. A device can perform one or more tasks. A device includes a computing system comprising electronics (e.g., sensors) and software. A device is uniquely identifiable through its computing system. A device may access internet services such as World Wide Web (WWW) or electronic mails (E-mails), and exchange information with another device or a server by using wired or wireless communication technologies, such as Bluetooth, Wi-Fi, Universal Serial Bus (USB), infrared, wireless connectivity, and the like. A device may offer one or more Graphical User Interfaces (GUIs) to allow, support, facilitate, enable, etc. users to among other things complete various tasks.

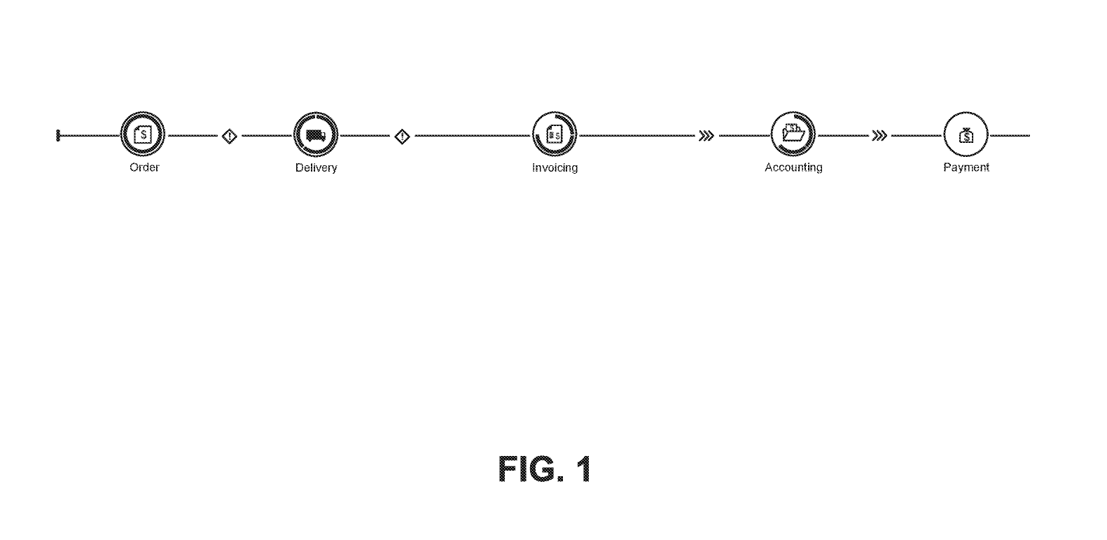

As a user employs a device to complete, pursue, etc. different activities, guided activity floorplans, or wizards can assist users in completing complex, complicated, infrequently performed, etc. tasks consisting of multiple steps. Such tasks may include for example creating a purchase order, generating a sales order, posting a financial transaction, submitting a request, configuring a system component, etc. See for example FIG. 1.

Depending upon the options, choices, etc. that may be selected by a user in a particular step of a task, the task may branch out into different flows with inter alia varying sub-steps, dependencies, decision points, etc.

Although guided activity floorplans are meant to streamline complex tasks, there are circumstances when they might actually increase the complexity for users. Such a situation could arise when for example a user needs to consider a piece of information from an earlier step in any of the subsequent steps. A user could try to retain the information (if for example they have any prior knowledge of the task and the guided activity), but this would among other things increase the cognitive load for the user. The user could also go back a couple of steps, but this would slow them down and decrease their efficiency and satisfaction. Designers could also repeat the piece of information in each step where it's necessary but this would unnecessarily clutter the screen.

By introducing an anchored information bar that inter alia presents sequentially the selected options from each previous step in a task, various of the challenges noted above may be obviated and among other things a user's work efficiency may be increased, the cognitive workload for the user may be decreased, the frequency of user errors may be reduced, user satisfaction may be increased or improved, etc.

An anchored information bar may appear anywhere on a display and the placement, orientation, size, content, etc. of the bar may be dynamically adjusted based on any number of criteria including for example device orientation, the nature (complexity, etc.) of a task, screen or display density, user actions or selections, etc.

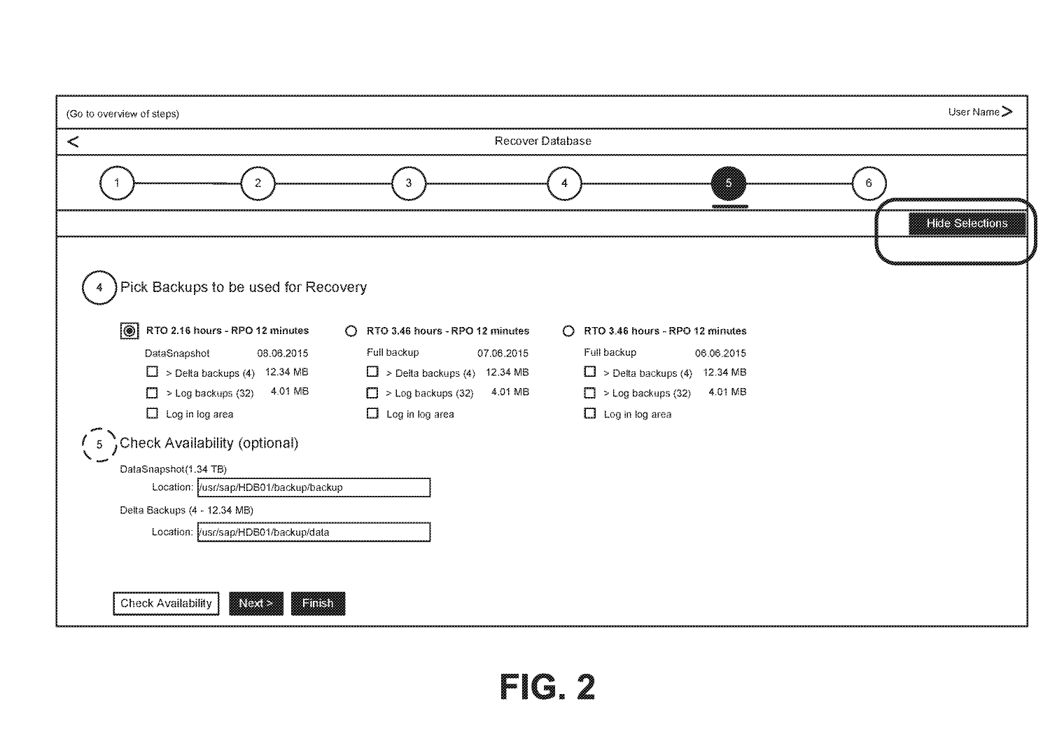

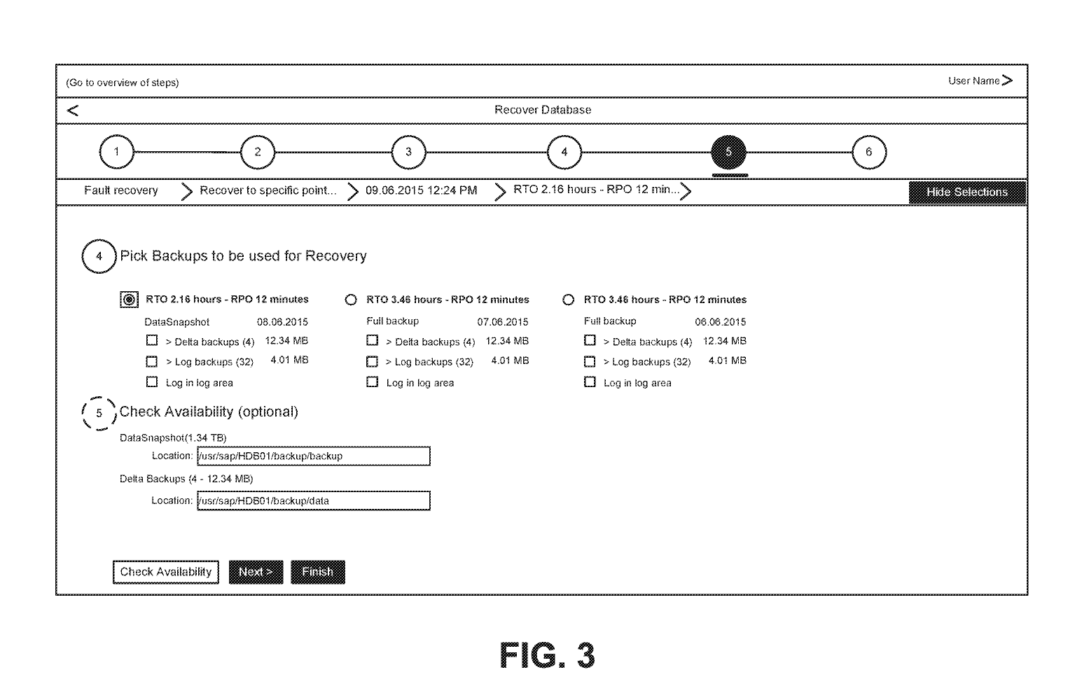

For example, an anchored information bar may appear below task steps that are listed on top of the screen (horizontal positioning). See for example FIG. 2 and FIG. 3.

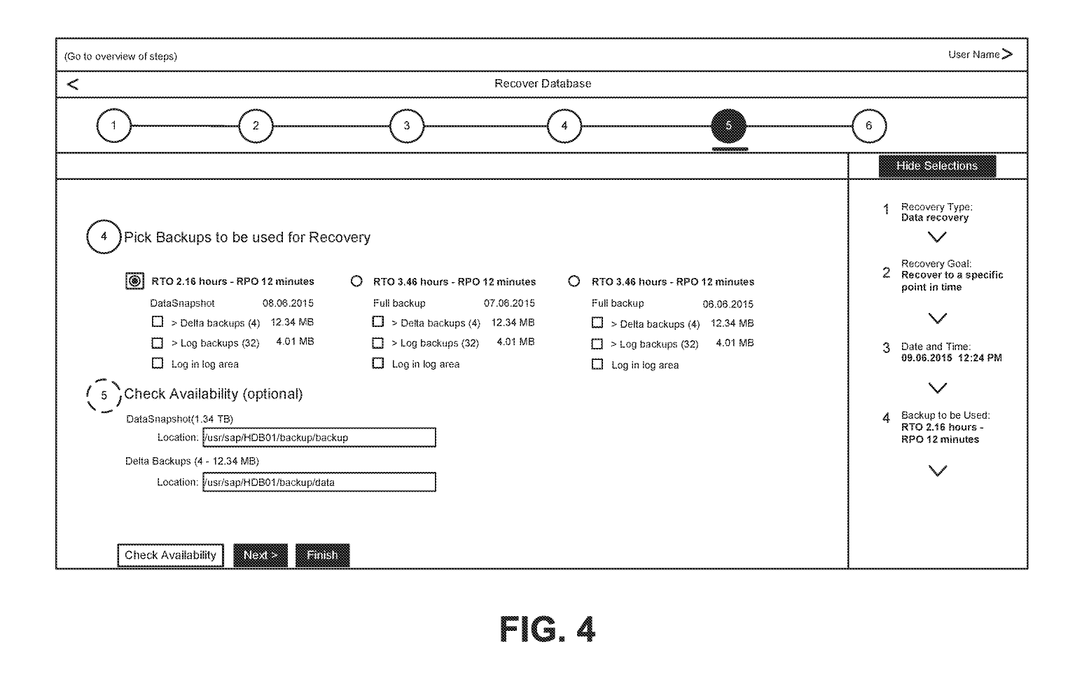

Alternatively, an anchored information bar may appear on the left or right side of the screen (vertical positioning). See for example FIG. 4.

A particular positioning option (such as for example horizontal, vertical, etc.) may offer among other things different capabilities, etc. For example, a vertical positioning option may support the display, presentation, etc. of more detailed (e.g., step) information (see for example FIG. 4).

The positioning options noted above are illustrative only and it will be readily apparent to one of ordinary skill in the relevant art that numerous other positioning options are easily possible.

The particulars of an anchored information bar may be managed by a user. For example:

1) A bar may be enabled (switched on) or disabled (switched off) by a user via any number of means including for example a control (such as a button, etc.) that may be presented on a display. See for example the ‘Show Selections’ control in FIG. 2 and the ‘Hide Selections’ control in FIG. 3.

2) A bar may be customized by a user in any number of ways including for example any combination of one or more of colors, fonts, skins, etc.

3) The location, positioning, placement, etc. of a bar may be ‘locked’ by a user to for example any combination of one or more of inter alia vertical, horizontal, top, bottom, left, right, etc.

The management options noted above are illustrative only and it will be readily apparent to one of ordinary skill in the relevant art that numerous other management options are easily possible.

The elements of an anchored information bar may be generated, created, etc. based on possibly among other things the particular steps in a task, previously completed steps, a current step, upcoming steps, configuration information, etc. and may be dynamically adjusted, updated, etc. as for example a user iterates through the steps in a task.

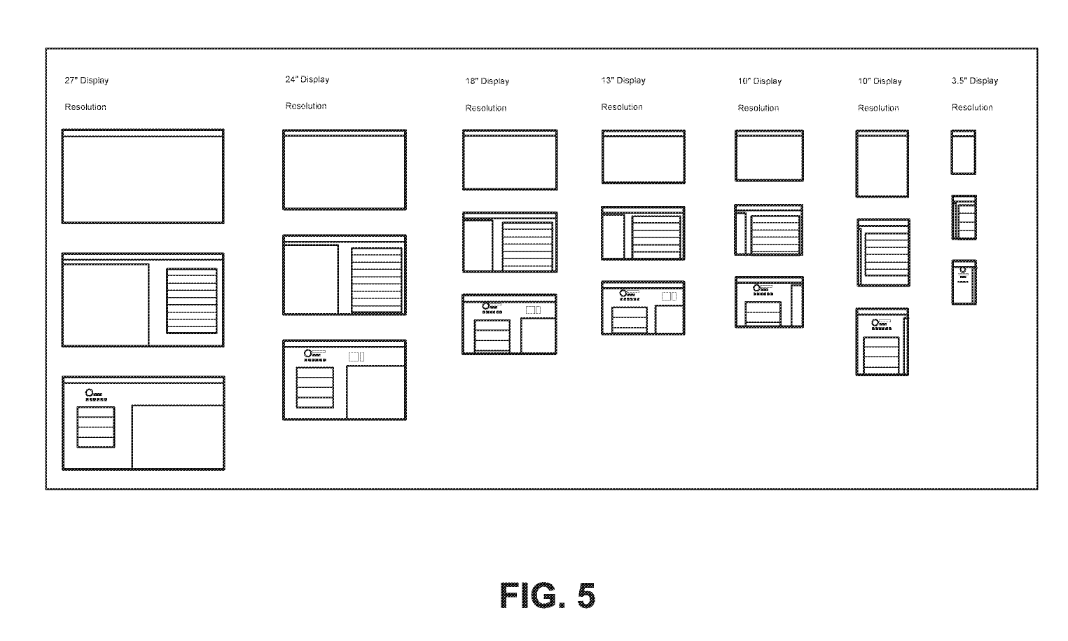

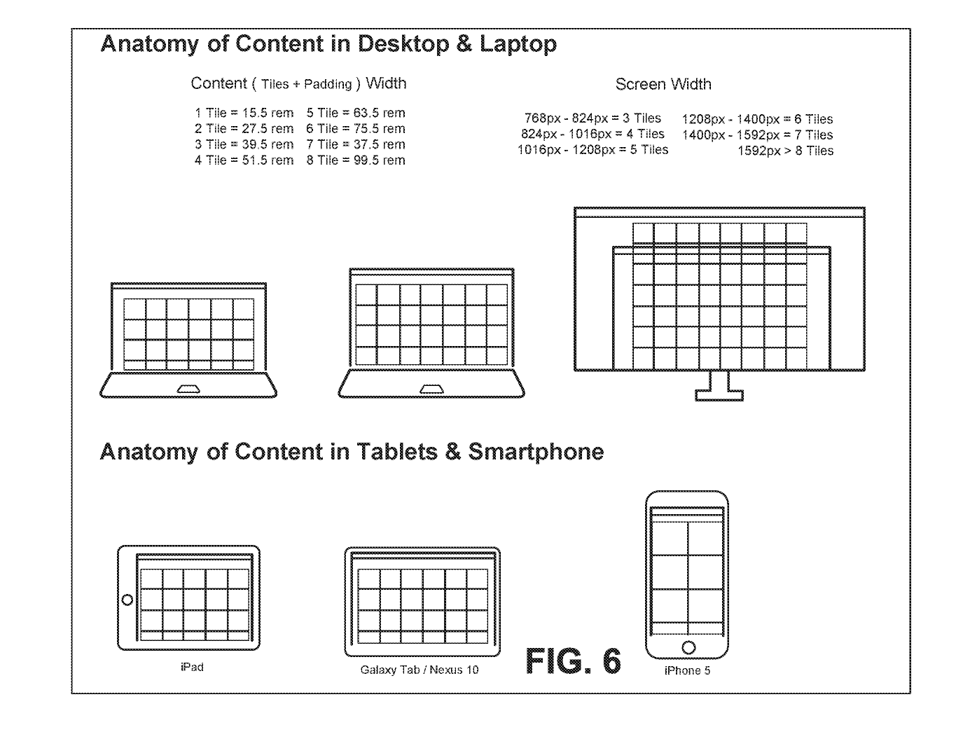

The particulars of an anchored information bar may be dynamically adjusted, altered, etc. based on for example changes that a user may make to the orientation of a device (e.g., shifting from a portrait orientation to a landscape orientation), the type of device that a user may employ at any given time (and shift between as they go about their activities), etc. See for example FIG. 5 and FIG. 6 (where for simplicity of exposition hypothetical measures, quantifiers, etc. are presented).

An anchored information bar may include among other things any number of additional items such as for example tips or hints, advertising, alerts, factoids, etc. Such items may for example be context sensitive or specific.

An anchored information bar may among other things provide visual clues, indicators, cues, etc. to distinguish between for example completed steps, visited but incomplete steps, unvisited steps, etc. in a task.

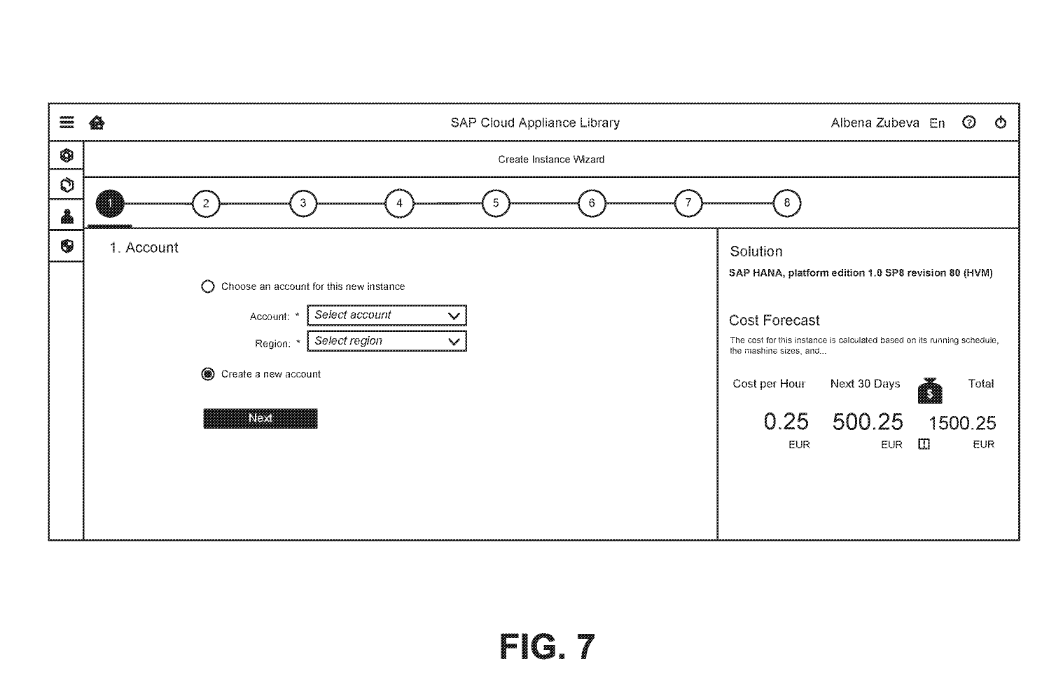

An anchored information bar may among other things offer any number of features, functions, capabilities, lookup, etc. For example, various what-if, forecast, calculation, estimation, etc. services (which may for example comprise one or more screens or displays, may accept and respond to user input, etc.) may be offered at any step of a task. See for example FIG. 7.

At any given time multiple anchored information bars may be active, visible to a user, in use, etc. Within such a plurality of anchored information bars each anchored information bar may operate independently, interoperate with aspects of one or more other anchored information bars, etc.

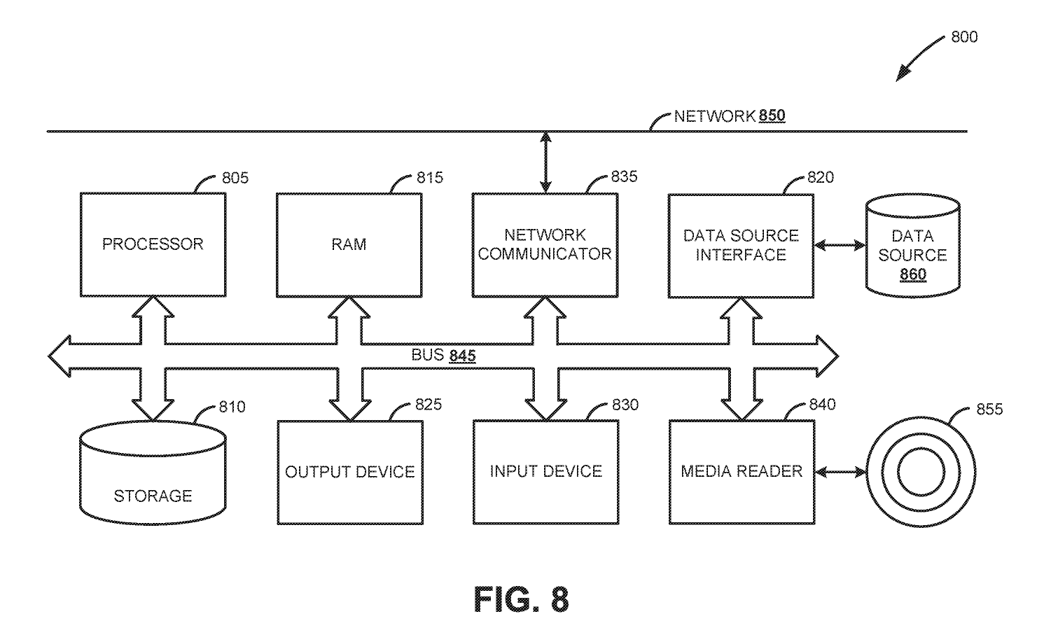

FIG. 8 is a block diagram of an exemplary computer system 800. The computer system 800 includes a processor 805 that executes software instructions or code stored on a computer readable storage medium 855 to perform the above-described activities. The processor 805 can include a plurality of cores. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. According to some embodiments, such as some in-memory computing system embodiments, the RAM 815 can have sufficient storage capacity to store much of the data required for processing in the RAM 815 instead of in the storage 810. In some embodiments, the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. The output devices 825 and input devices 830 may be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

Computer system 800 may include, support, service, etc. among other things:

1) One or more application, web, data, etc. servers which may comprise any combination of one or more of cloud-based and/or on-premise resources and which may be exposed, accessed, etc. via one or more networks.

2) One or more databases which may comprise any combination of one or more of a relational database, a multi-dimensional database, an in-memory facility, an object database, an eXtendable Markup Language (XML) document, flat files, or any other data storage system that supports structured and/or unstructured data. Such databases may be distributed among several different entities.

3) One or more devices such as for example any combination of one or more of a desktop computer, a notebook computer, a laptop computer, a tablet, a smartphone, a smartwatch, etc.

4) One or more administrators who may among other things engage in various management, control, configuration, support, etc. activities.

Various of the system element, component, etc. exchanges or interactions that were presented above may incorporate aspects of inter alia one or more Application Programming Interfaces (APIs), one or more standards-based artifacts (such as for example JSON, XML, etc.), one or more custom artifacts, etc.

In the above description, numerous specific details are set forth to provide a thorough understanding of embodiments. One skilled in the relevant art will recognize, however, that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

What is claimed is:

1. A computing system comprising:
a memory storing processor-executable program code; and
a processor to execute the processor-executable program code in order to cause the computing system to:
generate an anchored information bar for a task;
display the anchored information bar through a user interface; and
update aspects of the anchored information bar as a user iterates through a plurality of steps in the task.

2.
